(19) United States
(12) Patent Application Publication
(10) Pub. No.: US 2007/0260420 A1
(43) Pub. Date: Nov. 8, 2007

(54) AUTOMATED CALIBRATION SYSTEM

(75) Inventors: Simon B. Johnson, Bonney Lake, WA (US); Lev M. Bolotin, Kirkland, WA (US); Bradley Morris Johnson, Edmonds, WA (US)

Correspondence Address: ISHIMARU & ZAHRT LLP, 333 W. EL CAMINO REAL, SUITE 330, SUNNYVALE, CA, 94087, US

(73) Assignee: DATA I/O CORPORATION, Redmond, WA (US)

(21) Appl. No.: 11/743,568

(22) Filed: May 2, 2007

Related U.S. Application Data
(60) Provisional application No. 60/746,364, filed on May 3, 2006.

(51) Int. Cl. G06F 19/00; G01B 11/14

(52) U.S. Cl. 702/152; 356/614; 356/615; 382/100; 382/154; 702/85; 702/94; 702/95; 702/127; 702/150

(57) ABSTRACT

An automated calibration system that includes providing a three-dimensional calibration tool; engaging the three-dimensional calibration tool with a probe; and determining the position of the probe relative to an optical sensor based on the engagement of the three-dimensional calibration tool with the probe.

### CROSS-REFERENCE TO RELATED APPLICATION(S)

This application claims the benefit of U.S. Provisional Patent Application Ser. No. 60/746,364 filed May 3, 2006.

The present application contains subject matter related to co-pending U.S. patent application Ser. No. 11/381,532. The related application is assigned to Data I/O Corporation.

### TECHNICAL FIELD

The present invention relates generally to automated systems, and more particularly to an automated calibration system.

### BACKGROUND ART

In general, a pick-and-place machine contains a probe for the purpose of picking and placing components. This probe is usually mounted on a moveable head, often referred to as a pick-and-place head, which allows transporting of components between different locations within the working envelope of a robot. The location of the probe is known at all times via the use of encoders, which track the probe location through a two dimensional coordinate system (i.e.—X and Y). In order for components to be picked and placed accurately within the working envelope of the pick-and-place machine, the destinations have to be known absolutely. Presently, most systems learn exact destinations by having an operator manually teach the module picking positions and placing positions.

The main point of reference for any encoder is the home position. The home position is determined by moving along any axis in the direction of the home flag, until a home detection sensor is activated. This process can provide a reference point for all head movements. Although the home position provides a reference point, it is only a reference point relative to other positions.

While the home position can be detected quite accurately, module locations, such as tray pockets, programmer sockets, etc., within the robot working envelope are known to an approximate value. Consequently, the locations of these module locations are not known accurately enough for pick-and-place operations.

Presently, most pick-and-place operations require manual teaching of the exact location of a tray pocket by an operator. This is an extremely time consuming process that requires the following steps: home location, approximate pocket location, exact component location, and coordinate storage. First, an operator must locate the home coordinate system by aligning the robot with the home detection sensors for each coordinate axis (e.g.—X, Y and Z). Next, the operator repositions the robot to the approximate location of the tray pocket. Then, with the probe in the down position, the operator mainly “jogs” the pick-and-place head until the probe meets a feature or part, such as a semiconductor device or center of a cavity.

Once a visual check by the operator has ascertained that the probe is positioned at the correct destination, the operator instructs the robot to remember the current coordinates. This procedure is repeated until all the features have been determined by the coordinate system. Not only is this process costly and time consuming, but it is also fraught with human error, such as unsophisticated operator visual identification steps that lead to inaccuracies in picking a part. Additionally, with automated programming systems, where the modules need to be exchanged quite often, productivity is severally curtailed due to time spent on additional machine setup steps and operator learning curve.

To compensate for inaccuracies in picking a part, high-end, expensive, pick-and-place machines usually come equipped with an upward looking camera that is used to compensate for inaccuracies in picking parts. After a part is picked from an input tray, the gantry moves to a known location over the camera. Vision software can then determine offset adjustments for correct socket placement, for example. Unfortunately, the camera and the software to run it are often subject to vision problems with the camera and inaccuracies in the software.

Thus, a need still remains for a reliable automated calibration system and method of application, wherein the automated calibration system does not require a high level of operator interaction to locate features. In view of the ever-increasing commercial competitive pressures, increasing consumer expectations, and diminishing opportunities for meaningful product differentiation in the marketplace, it is increasingly critical that answers be found to these problems. Moreover, the ever-increasing need to save costs, improve efficiencies, and meet such competitive pressures adds even greater urgency to the critical necessity that answers be found to these problems.

Solutions to these problems have been long sought but prior developments have not taught or suggested any solutions and, thus, solutions to these problems have long eluded those skilled in the art.

### DISCLOSURE OF THE INVENTION

The present invention provides an automated calibration system that includes providing a three-dimensional calibration tool; engaging the three-dimensional calibration tool with a probe; and determining the position of the probe relative to an optical sensor based on the engagement of the three-dimensional calibration tool with the probe.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is an isometric view of an automated programming system in accordance with an embodiment of the present invention;

FIG. 2 is an isometric view of an automated programming system with a cover removed in accordance with an embodiment of the present invention;

FIG. 3 is a schematic view of an automated calibration system in accordance with an embodiment of the present invention;

FIG. 4 is a top view of a head system and an optics system, in accordance with an embodiment of the present invention;

FIG. 5 is an isometric view of a three-dimensional calibration tool, in accordance with an embodiment of the present invention;

FIG. 6 is a front view of a three-dimensional calibration tool and a probe, in accordance with an embodiment of the present invention;

FIG. 7 is a front view of a three-dimensional calibration tool and a probe, in accordance with another embodiment of the present invention;

FIG. 8 is a front view of a three-dimensional calibration tool and a probe, in accordance with another embodiment of the present invention; and

FIG. 9 is a flow chart of an automated calibration system for an automated calibration system, in accordance with an embodiment of the present invention.

### BEST MODE FOR CARRYING OUT THE INVENTION

The following embodiments are described in sufficient detail to enable those skilled in the art to make and use the invention, and it is to be understood that other embodiments would be evident based on the present disclosure and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known system configurations, and process steps are not disclosed in detail. Likewise, the drawings showing embodiments of the invention are semi-diagrammatic and not to scale and, particularly, some of the dimensions are for the clarity of presentation and are shown exaggerated in the drawing FIGs. In addition, where multiple embodiments are disclosed and described having some features in common, for clarity and ease of illustration, description, and comprehension thereof, similar and like features one to another will ordinarily be described with like reference numerals.

The term “horizontal” as used herein is defined as a plane parallel to the plane or surface of a substrate, regardless of its orientation. The term “vertical” refers to a direction perpendicular to the horizontal as just defined. Terms, such as “on”, “above”, “below”, “bottom”, “top”, “side” (as in “sidewall”), “higher”, “lower”, “upper”, “left”, “right”, “over”, and “under”, are defined with respect to the horizontal plane. The terms “example” or “exemplary” are used herein to mean serving as an instance or illustration. Any aspect or embodiment described herein as an “example” or “exemplary” are not necessarily to be construed as preferred or advantageous over other aspects or designs.

Generally, the automated calibration system of the present invention provides a method and a system for calibrating probes to an optical sensor. The probes can be calibrated with respect to the optical sensor by aligning each of the probes, an offset distance from a reference point of a three-dimensional calibration tool, and determining the height of the probe on either side of the three-dimensional calibration tool. If the height of the probe on either side of the three-dimensional calibration tool is substantially equivalent, then the probe is properly calibrated with respect to the optical sensor; and, if the height of the probe on either side of the three-dimensional calibration tool is substantially unequal, then the location of the probe can be properly re-calibrated with respect to the optical sensor.

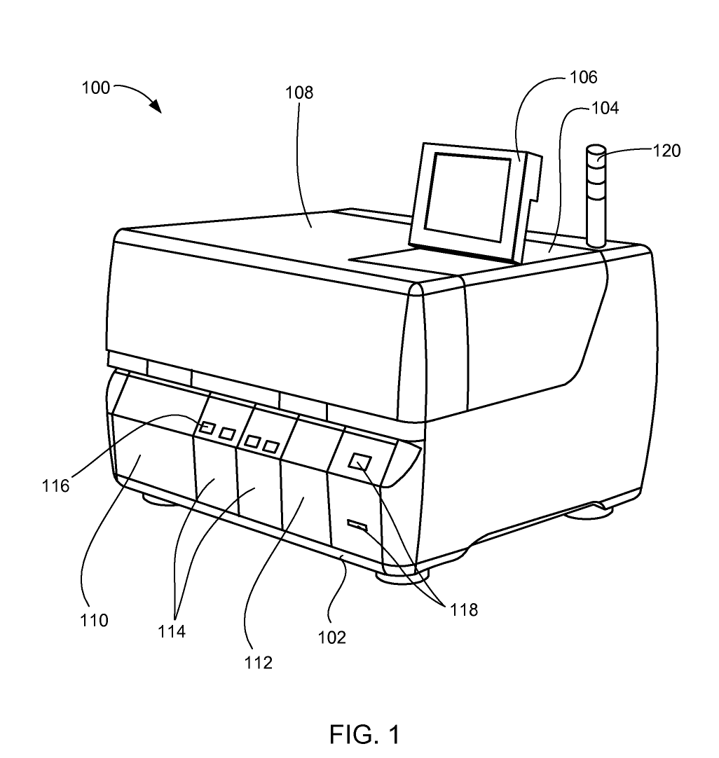

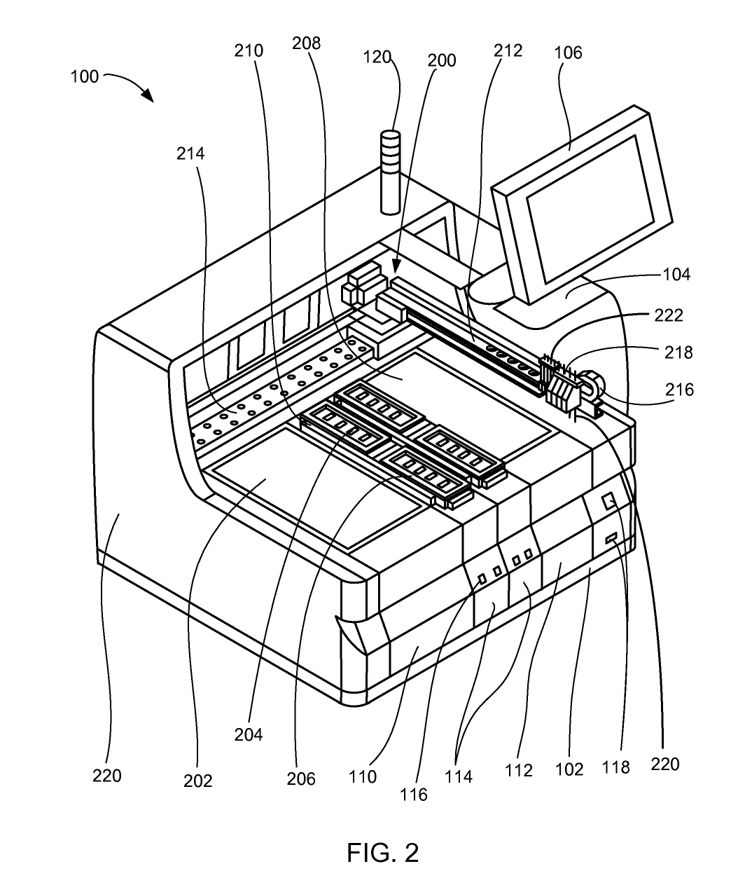

FIGS. 1 and 2, which follow, depict an exemplary apparatus that may employ the automated calibration system in accordance with an embodiment of the present invention. It is to be understood that FIGS. 1 and 2 depict by way of example and not by limitation, an exemplary apparatus that may employ the automated calibration system, and it is not to be construed as limiting.

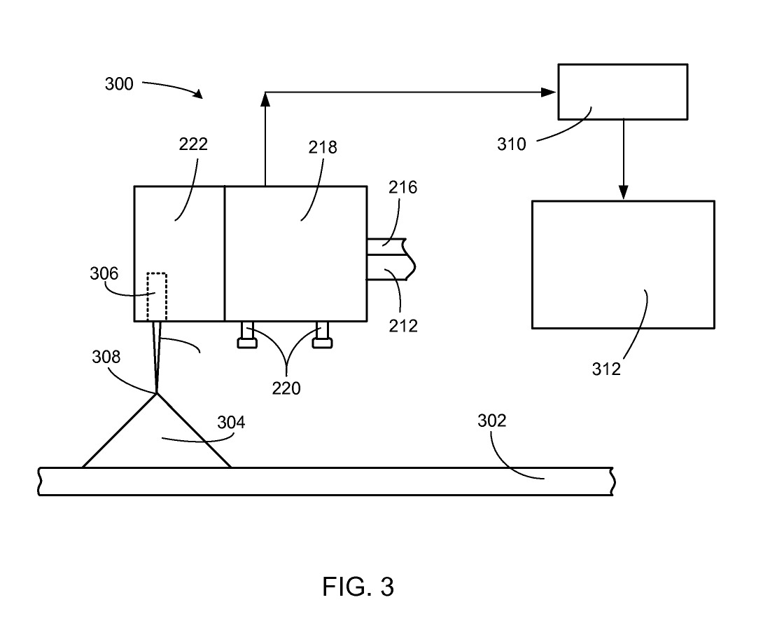

Referring now to FIG. 1, therein is shown an isometric view of an automated programming system 100 in accordance with an embodiment of the present invention. The automated programming system 100 includes a frame 102, a stand 104, a monitor 106, a cover 108, an input module 110, an output module 112, programming modules 114, a module control 116, control electronics 118, and a status indicator 120. As an exemplary illustration, the automated programming system 100 may include an automated calibration system 300, of FIG. 3, within a desktop handler system employing a pick-and-place mechanism. The desktop handler system is a portable programming system wherein handles may be built-in to enhance portability.

The frame 102 is the main housing that holds all the elements together and provides structural support. The stand 104 can provide support for the monitor 106. By way of example and not by way of limitation, the monitor 106 may include a touch screen user interface system that provides visual feedback to an operator.

The cover 108 is also mounted to the frame 102 and covers the working envelope of the machine. The cover 108 offers protection to the input module 110, the output module 112, and the programming modules 114 from dust and debris within the working environment. Additionally, the cover 108 protects an operator from unintended operational hazards.

Devices, media and/or components may enter and exit the automated programming system 100 via removable modules, such as the input module 110 or the output module 112. By way of example, the input module 110 and the output module 112 may be configured to accommodate trays, receptacles or other carriers, which may conform to Joint Electron Device Engineering Council (JEDEC) standards. However, it is to be understood that the present invention is not to be limited to such configurations. In accordance with the present invention the input module 110 and the output module 112 may accommodate any device tray, receptacle or carrier.

The programming modules 114 provide the core processing interface for the automated programming system 100. The programming modules 114 include one or more removable modules that interface with the automated programming system 100. Each of the programming modules 114 may also be configured to accommodate trays, receptacles, or carriers, which may conform to JEDEC standards. These trays, receptacles, or carriers may contain a socket adapter(s) 204, of FIG. 2, an actuator(s) 206, of FIG. 2, and a reject bin 210, of FIG. 2, for receiving devices. After the devices, such as un-programmed programmable media, are placed within the socket adapters 204, the actuators 206 close the sockets so that the devices are appropriately connected to the programming modules 114 of the automated programming system 100.

Additionally, each of the programming modules 114 possesses the module control 116. The module control 116 allows an operator to initiate system configuration setup, such as the identification of the module, the configuration of the module, the geometry of the module and the location of the module within the system, by manually engaging the module control 116.

The control electronics 118 are also mounted on the frame 102. The control electronics 118 provide an electrical interface for the automated programming system 100. For example, the control electronics 118 may possess a power ON/OFF switch and/or digital air boards.

Notably, the automated programming system 100 does not rely on an external vacuum system, which greatly enhances the portability of the machine. The automated programming system 100 possesses an on-board vacuum system that is powered by electrical current, therefore, the automated programming system 100 is a self-sufficient system that only requires an electrical current for operation. Additionally, the back of the automated programming system 100 may possess additional power modules.

The status indicator 120 is also mounted on the frame 102. The status indicator 120 provides visual feedback, via a non-text error message, to the user about operation status. As an exemplary illustration, the status indicator 120 may use a multi-color scheme employing more than one light combination. The particular combination can be done in such a way that a green light may indicate that everything is operation normal, a yellow light may indicate that attention may be needed soon and a red light may indicate that there is a problem, error, or normal termination of a job, and operations should or will be stopped. According to this illustration, a red light requires immediate operator attention. However, it is to be understood that any color scheme may be used to convey the notions of operations normal, attention may be needed soon, and operation error.

For purposes of illustration, the following color coded combinations may occur:
Green=machine is running
Yellow=machine performance has degraded and may result in the machine eventually stopping
Red=machine is stopped. This can be from an error or normal termination of job.

Referring now to FIG. 2, therein is shown an isometric view of the automated programming system 100 with the cover 108, of FIG. 1, removed in accordance with an embodiment of the present invention. The automated programming system 100 includes the frame 102, the stand 104, the monitor 106, the input module 110, the output module 112, the programming modules 114, the module control 116, the control electronics 118, the status indicator 120, a robotics system 200, an input device receptacle area 202, the socket adapters 204, the actuators 206, an output device receptacle area 208, the reject bin 210, a gantry 212, a track 214, an arm 216, a head system 218, a probe 220, and an optics system 222.

The robotics system 200, and more generally the automated programming system 100, can be controlled by a user interface system, such as a graphical non-text user interface system. In accordance with the scope of the present invention, a non-text user interface system uses only numbers and symbols to communicate information to an operator and not written words. The user interface system can provide feedback to an operator via visual or auditory stimulus.

The user interface system, displayed by the monitor 106, provides a real time image of the working envelope (i.e.—the system configuration). The working envelope includes the input module 110, the output module 112, the programming modules 114, the input device receptacle area 202, the socket adapters 204, the actuators 206, the output device receptacle area 208, and/or the reject bin 210.

By modeling the real time configuration of the working envelope, the monitor 106 helps to eliminate operator mistakes during set up of the automated programming system 100. Additionally, the real time image on the monitor 106 can increase operator productivity due to its accurate representation of the working envelope.

Not only does the user interface system display a real time image of the working envelope, but it may also provide programming setup and status information. In general, the user interface system of the present invention includes the following categories to control a programming system: job selection, programming, device and hardware detection, and statistical job feedback. These categories are controlled via a plethora of functions, such as job status inquires, job control, job tools, socket use, job selection, receptacle map, and measure receptacle. These functions provide a workable user interface for the automated programming system 100 that do not require textual representation, and therefore allow global application of the user interface.

Additionally, the user interface system can be configured for remote operation, as well as, remote diagnostics access.

During operation, the robotics system 200, which includes a pick-and-place system (e.g.—the head system 218), retrieves one or more devices (not shown) from the input device receptacle area 202, located over the input module 110. The robotics system 200 then transports the device(s) to the programming modules 114 which possess the socket adapters 204 and the actuators 206. Once the socket adapters 204 engage the devices, programming may commence. Once programming is complete, the robotics system 200 then transports the good devices to the output device receptacle area 208, located over the output module 112, and transports the bad devices to the reject bin 210. By way of example, the input device receptacle area 202 and the output device receptacle area 208 may be designed to accommodate device trays, receptacles, or carriers with one or more pockets.

The robotics system 200 is attached to an L-shaped base, which is part of the frame 102. The L-shaped base provides a rigid, lightweight, cast, platform for the robotics system 200. Additionally, the L-shaped base allows easy access to the working envelope of the automated programming system 100. The L-shaped base may contain a smart interface system for interfacing with intelligent modules.

The robotics system 200 includes the gantry 212, the track 214, the arm 216, the head system 218, the probe 220, and the optics system 222. The gantry 212 supports the arm 216, the head system 218, the probe 220 and the optics system 222. The gantry 212 slides back and forth (e.g.—in the X direction) across the track 214. The head system 218, the probe 220, and the optics system 222 slide back and forth (e.g.—in the Y direction) across the arm 216 supported by the gantry 212. The head system 218 may additionally move up and down (i.e.—in the Z direction) and rotate (i.e.—in the theta direction).

The head system 218, may include by way of example and not by way of limitation, a pick-and-place head system, which can employ multiple design configurations, such as a multi-probe design. The head system 218 is a small sized, lightweight system to facilitate fast and accurate movements. Imprecise movements of the head system 218 are accommodated for by a built-in compliance mechanism. The built-in compliance mechanism can be based upon mechanical principles, such as a spring, or upon electrical principles, for example.

In further attempts to reduce the size and weight of the head system 218, particular aspects of the invention may employ limited theta or rotational movement for each up and down or Z position.

The head system 218 may be powered by an electrical stimulus, a pneumatic stimulus or any stimulus that produces the desired result of moving the head system 218. Uniquely, the probe 220 of the head system 218 does not rely on an external air supply. If pneumatics are used to operate the probe 220, they are provided via an on-board vacuum system. Therefore, the automated programming system 100 can be designed to only require electrical power for operation. By not requiring each potential operations facility to possess a clean and special external air supply, the automated programming system 100 becomes universally portable and employable.

Furthermore, adjacent to the head system 218 is the optics system 222 that is displaceable due to its attachment to the head system 218. The optics system 222 enables the automated programming system 100 to automatically map the physical characteristics and geometry of any module placed within the working envelope of the automated programming system 100. By way of example, for each module, such as a tray, receptacle, or carrier, placed within the automated programming system 100, the optics system 222 can automatically map the physical characteristics of the module, such as the row offset, the row pitch, the column offset, and the column pitch to determine the location of each feature or opening within the module.

These automatic measurements will provide information about the exact coordinates (e.g.—X, Y, Z and/or theta directions) for each feature or opening within the working envelope of the automated programming system 100. The present invention may employ a one, two, three, or four dimensional coordinate system. Additionally, by way of example and not by way of limitation, a feature may include the center of a cavity, the center of a socket adapter, and/or the center of a component, such as a device or media. Furthermore, a module may include an M×N array of features, wherein M and N are positive integers.

The optics system 222 employs optical methods based upon reflectivity and specifically designed algorithms to calculate the exact coordinates for each feature or opening. This system is designed in such a way that the operator no longer has to manually determine the exact coordinates of each feature or opening, which saves the operator time and prevents operator input error. Additionally, the optics system 222 may be part of an automated location system.

Referring now to FIG. 3, therein is shown a schematic overview of the automated calibration system 300 in accordance with an embodiment of the present invention. The automated calibration system 300 includes the gantry 212, the arm 216, the head system 218, the probe 220, the optics system 222, a substrate 302 (such as a tooling plate surface), a three-dimensional calibration tool 304, an optical sensor 306 (shown in hidden outline), a reference point 308, a motor encoder/controller 310, and a processing unit 312. By way of example, the automated calibration system 300 may be a part of the automated programming system 100, of FIG. 1, and the substrate 302 may be a part of the working envelope of the automated programming system 100. However, it is to be understood that the substrate 302 may be a part of any system that allows calibration of the head system 218 and the optics system 222 via the three-dimensional calibration tool 304. For example, the substrate 302 may include any surface such as a tray, a receptacle, or a carrier. The tooling plate is simply the surface to which all modules are fastened: programmers, platens for trays, etc.

Furthermore, although the automated calibration system 300 of the present embodiment depicts the head system 218 with two of the probe 220, it is to be understood that the head system 218 may include one or more of the probe 220. In accordance with the scope of the present invention, the number of the probe 220 is only to be limited by the design and/or the processing requirements of the system that incorporates the automated calibration system 300. By way of example, the probe 220 can be used for picking devices, components or media from within features located by the optical sensor 306.

During operation, the optical sensor 306 of the automated calibration system 300 locates the reference point 308, such as the apex of the three-dimensional calibration tool 304, by measuring changes in reflectivity. However, in accordance with the scope of the present invention, it is to be understood that the optical sensor 306 may detect any location or feature within the working envelope of a robot system, such as a tray pocket or programmer socket, for example. The optical sensor 306 can be designed to emit a light, such as a monochromatic light, which tracks its location over the substrate 302. The light emitted by the optical sensor 306 and reflected by the substrate 302 may also provide a visual representation as to the location of the optical sensor 306.

Furthermore, although the three-dimensional calibration tool 304 is depicted as pyramidal in shape, this is not to be construed as limiting. In accordance with the present invention, the three-dimensional calibration tool 304 may include any design, shape or configuration that permits calibration of the probe 220 with respect to the optical sensor 306.

Upon determination of the reference point 308, the signal representing the change in reflectivity as measured by the optical sensor 306 is then sent to the motor encoder/controller 310. The motor encoder/controller 310 tracks the movements of the optical sensor 306 and assigns a value to this signal. The motor encoder/controller 310 then sends this value to the processing unit 312, such as a computer, for example. The processing unit 312 processes this value (i.e.—the location of the change in reflectivity) and assigns a coordinate position for later use.

As an exemplary illustration, the motor encoder/controller 310 may gauge the distance traveled by the optical sensor 306 by counting the motor pulses of the motor encoder/controller 310 or units of measurement, such as millimeters. For example, the pulses of the motor encoder/controller 310 may be a specified number of rotations of a sprocket, a drive wheel, or any other type of mechanism that has a relatively constant magnitude of motion with respect to the distance traveled by the optical sensor 306. These motor pulses are then relayed to the processing unit 312, wherein a program or software stored and executed within the processing unit 312 can track the position or location of the optical sensor 306. The program or software of the processing unit 312 converts the motor pulses of the motor encoder/controller 310 into X, Y, Z and/or theta directions corresponding to the number of motor pulses in the X, Y, Z and/or theta directions.

In accordance with an aspect of the present invention, the shift associated with the perceived location of the teaching targets can be minimized by tightly coupling the optical sensor 306 with the motor encoder/controller 310.

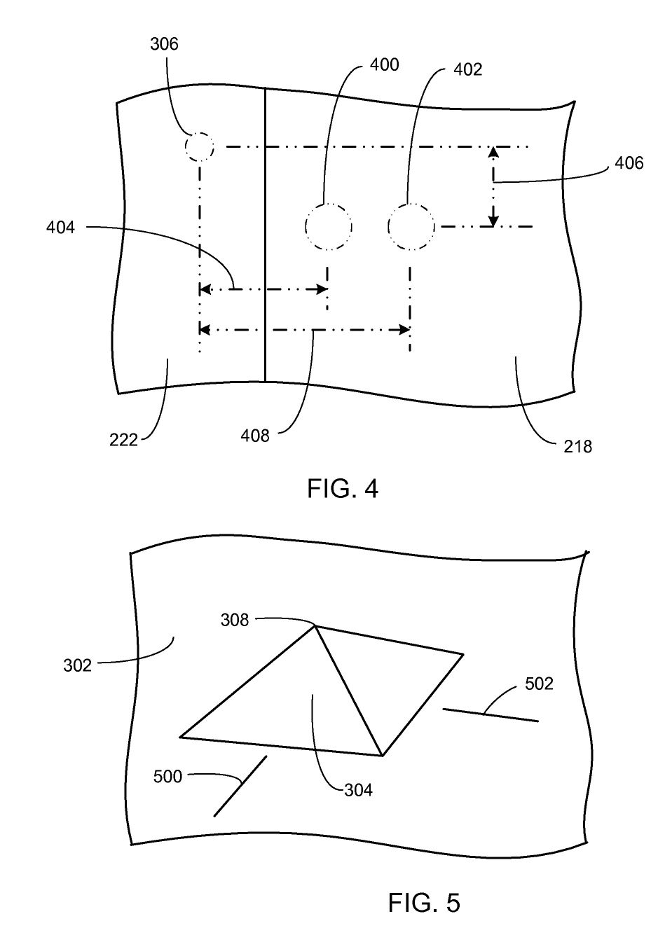

Once the location of the reference point 308 has been determined by the optical sensor 306, the automated calibration system 300 then aligns the probe 220 over the reference point 308. The probe 220 is aligned over the reference point 308 by accounting for a known/given offset of the probe 220 from the optical sensor 306. FIG. 4 will describe this known/given offset of the probe 220 in greater detail.

Referring now to FIG. 4, therein is shown a top view of the head system 218 and the optics system 222, in accordance with an embodiment of the present invention. This view depicts the relative location of the optical sensor 306 (shown in phantom outline) with respect to a first probe 400 (shown in phantom outline) and a second probe 402 (shown in phantom outline); however, this is not limiting. In accordance with the scope of the present invention, it is to be understood that the head system 218 may employ one or more of the probe 220, of FIG. 3, such as the first probe 400 and the second probe 402, as required by the design and/or the processing requirements of the system that incorporates the automated calibration system 300, of FIG. 3.

Per this embodiment, the first probe 400 can be offset from the optical sensor 306 by a first probe X distance 404 and a Y distance 406 (e.g.—a known/given offset of the probe 220); and, the second probe 402 can be offset from the optical sensor 306 by a second probe X distance 408 and the Y distance 406 (e.g.—a known/given offset of the probe 220). Consequently, the first probe 400 and the second probe 402 may require calibration with respect to the optical sensor 306 to ensure that the first probe 400 and the second probe 402 will descend to the feature or location as detected by the optical sensor 306. Although the present embodiment depicts a single Y offset distance (i.e.—the Y distance 406), it is to be understood that the automated calibration system 300 of the present invention can handle or process different Y offset values or distances for each of the probe 220.

Commonly, the X and Y offset values for the probe 220, such as the first probe 400 and the second probe 402, from the optical sensor 306 are known/given. But, if the known/given X and Y offset values of the probe 220 are inherently incorrect or they are altered by maintenance or manufacturing operations, then the ability of the probe 220 to properly align with the feature or location as detected by the optical sensor 306 can be affected. Consequently, the present inventors have discovered a system and method that permits automated calibration for each of the probe 220 with respect to the optical sensor 306 by employing the automated calibration system 300. Because the optical sensor 306 can be used to teach absolute locations for pick and place operations, it becomes critical that pick and place locations become known as accurately as possible.

Referring now to FIG. 5, therein is shown an isometric view of the three-dimensional calibration tool 304, in accordance with an embodiment of the present invention. The three-dimensional calibration tool 304 is situated such that the reference point 308 is located above the intersection of a first reference 500 and a second reference 502. By way of example, the first reference 500 may be formed along an X-axis and the second reference 502 may be formed along a Y-axis. Although the present embodiment depicts the three-dimensional calibration tool 304 as a pyramidal structure, it is to be understood that the three-dimensional calibration tool 304 may include any three-dimensional structure that allows calibration of the probe 220, of FIG. 3, with respect to the optical sensor 306, of FIG. 3. As an exemplary illustration, the three-dimensional calibration tool 304 may include any structure which provides a surface that allows translation from Z to X.

By way of example, the reference point 308 can be the common point of reference for all other locations within a system's working envelope. The reference point 308 can be defined by scanning the optics system 222, of FIG. 3, back and forth across each of the first reference 500 and the second reference 502 and registering the changes in reflectivity. For example, the first reference 500 and the second reference 502 can be non-reflective markings placed against a reflective surface, such as the substrate 302, or vice-versa. Once the reference point 308 is determined, the probe 220 can be aligned over it and the calibration process can begin. Additionally, once the reference point 308 is determined, features, such as cavities, socket adapters and devices, can be mapped out (i.e.—their X, Y, Z, and theta locations determined) with respect to the reference point 308.

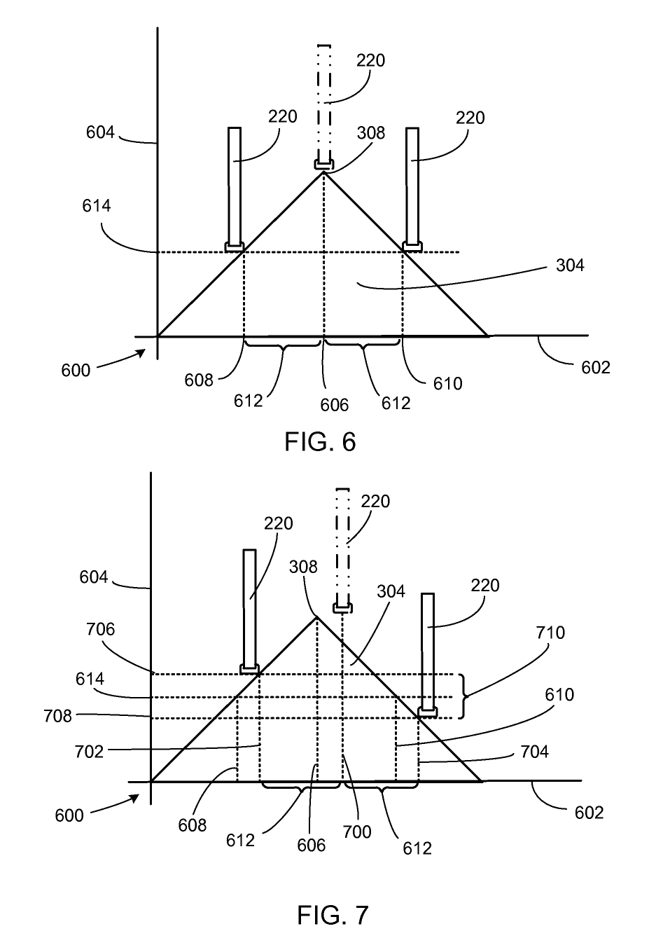

FIG. 6 depicts by way of example and not by limitation, a method that can be employed for calibrating the probe 220, of FIG. 3, with respect to the optical sensor 306, of FIG. 3, and is not to be construed as limiting. For ease of discussion with regards to FIG. 6, it will be assumed that each face of the three-dimensional calibration tool 304 will be at a forty-five degree (45°) angle with respect to the surface over which it is placed (e.g.—the substrate 302, of FIG. 3). Additionally, a delta axis 602 of a reference coordinate system 600 may represent both an X-axis orientation or a Y-axis orientation. As an exemplary illustration, the representation of FIG. 6 may depict the calibration of the probe 220, which already is properly calibrated.

Referring now to FIG. 6, therein is shown a front view of the three-dimensional calibration tool 304 and the probe 220, in accordance with an embodiment of the present invention. The reference coordinate system 600, which includes the delta axis 602 and a Z-axis 604, has been positioned adjacent the three-dimensional calibration tool 304 to provide a frame of reference for purposes of discussion.

Generally, the present embodiment calibrates the position of the probe 220 with respect to the optical sensor 306, of FIG. 3, by aligning the probe 220 over the reference point 308, and offsetting the probe 220 a specific distance on either side of the reference point 308 along the delta axis 602. After offsetting the probe 220 a specific distance on either side of the reference point 308 along the delta axis 602, the probe 220 is then lowered until the probe 220 contacts or engages the three-dimensional calibration tool 304. Measurements are performed for each of the X, Y and Z axes for the location of the probe 220, wherein the measurements allow calculation of the correct offset for the probe 220 with respect to the optical sensor 306.

More specifically, the probe 220 can be calibrated with respect to the optical sensor 306 by performing the following method of the present invention. However, it is to be understood that many modifications, additions, and/or omissions may be made to the present invention without departing from the scope or spirit of the claimed subject matter. For example, the process may include more, fewer, or other steps.

Initially, the optical sensor 306 of the optics system 222, of FIG. 3, is aligned over the reference point 308. By way of example, the reference point 308 may include a perceived location of a pyramid apex as determined by the optical sensor 306. Next, the probe 220 is then set over the reference point 308 by accounting for the known/given offset of the probe 220 from the optical sensor 306. The probe 220, shown in phantom outline, represents the start position of the probe 220 that is located by a correct known/given offset value (i.e.—the probe 220 is located over the reference point 308). By way of example, the known/given offset of the probe 220 from the optical sensor 306 may include an X-offset value and/or a Y-offset value. One of the aspects of the present embodiment is to verify the correctness of the known/given offset of the probe 220 from the optical sensor 306.

Once the automated calibration system 300, of FIG. 3, has aligned the probe 220 over what it believes to be the reference point 308, the probe 220 is then offset an equal distance in opposite directions from the reference point 308 along the delta axis 602, wherein the reference point 308 can correspond to a delta reference point 606. Per the present embodiment, the probe 220 is offset to a delta one location 608 and a delta two location 610 by a specified distance 612. The specified distance 612 can be an equal distance in opposite directions from the reference point 308 along the delta axis 602. By way of example, the specified distance 612 can be an arbitrary distance that will cause the probe 220 to land approximately one-half (½) the way down the face of the three-dimensional calibration tool 304. For purposes of illustration, the delta one location 608 and the delta two location 610 can be calculated by the following formulas:

the delta one location 608=the delta reference point 606 (plus) the known/given offset of the probe 220 (minus) the specified distance 612

the delta two location 610=the delta reference point 606 (plus) the known/given offset of the probe 220 (plus) the specified distance 612

All values used in the above equations can be either X-axis values or Y-axis values.

Per the present embodiment, the delta one location 608 and the delta two location 610 correspond to a Z-axis value 614. It has been discovered by the present inventors that when the probe 220 descends to the same height on either side of the reference point 308 of the three-dimensional calibration tool 304 (e.g.—the Z-axis value 614 is the same for the delta one location 608 and the delta two location 610), then the known/given offset of the probe 220 is calibrated properly with respect to the optical sensor 306. By way of example, the height of the probe 220 (i.e.—the Z-axis value 614) can be measured when the probe encounters the resistance of the three-dimensional calibration tool 304. This calibration method, as employed by the automated calibration system 300, ensures that each location and/or feature within the working envelope of the robotics system 200, of FIG. 2, is known accurately by the probe 220.

It is to be understood that this calibration method can be repeated for each offset axis (e.g.—the X-axis and the Y-axis) of the probe 220. For example, if the first set of calculations are performed for the X-axis, then the second set of calculations can be performed for the Y-axis, or vice-versa. Additionally, it is to be understood that this calibration method can also be repeated for each of the probe 220 within the head system 218, of FIG. 3.

Furthermore, it is to be understood that each of the coordinates for the X, Y and Z values of the probe 220 location are measured by the motor encoder/controller 310, of FIG. 3, and that software within the processing unit 312, of FIG. 3, then calculates any adjustments that need to be made to the known/given offset value for the probe 220. For example, the processing unit 312 may determine the position of the probe 220 relative to the optical sensor 306 based on the Z-axis values or height values obtained from the engagement of the probe 220 with the three-dimensional calibration tool 304.

FIG. 7 depicts by way of example and not by limitation, a method that can be employed for calibrating the probe 220, of FIG. 3, with respect to the optical sensor 306, of FIG. 3, and is not to be construed as limiting. For ease of discussion with regards to FIG. 7, it will be assumed that each face of the three-dimensional calibration tool 304 will be at a forty-five degree (45°) angle with respect to the surface over which it is placed (e.g.—the substrate 302, of FIG. 3). Additionally, the delta axis 602 of the reference coordinate system 600 may represent both an X-axis orientation or a Y-axis orientation. As an exemplary illustration, the representation of FIG. 7 may depict the calibration of the probe 220, which is not properly calibrated.

Referring now to FIG. 7, therein is shown a front view of the three-dimensional calibration tool 304 and the probe 220, in accordance with another embodiment of the present invention. FIG. 7 depicts a similar configuration as to that shown in FIG. 6, and consequently, only the differences between the figures will be described, to avoid redundancy. This view includes the probe 220, the three-dimensional calibration tool 304, the reference point 308, the reference coordinate system 600, the delta axis 602, the Z-axis 604, the delta reference point 606, the delta one location 608, the delta two location 610, the specified distance 612, the Z-axis value 614, a delta prime reference point 700, a delta one prime location 702, a delta two prime location 704, a first Z-axis location 706, a second Z-axis location 708, and a Z-height difference value 710.

The reference coordinate system 600 has been positioned adjacent the three-dimensional calibration tool 304 to provide a frame of reference for purposes of discussion. Per this embodiment, alignment of the probe 220 over the reference point 308 is attempted by locating the optical sensor 306, of FIG. 3, over the perceived location of the reference point 308 and then adding the known/given offset value for the probe 220. It is to be understood, that if the known/given offset value for the probe 220 is incorrect, the probe 220 will most likely not be aligned over the reference point 308. The probe 220, shown in phantom outline, represents the start position of the probe 220 that is located by an incorrect known/given offset value. The start position of the probe 220 can be represented by the delta prime reference point 700.

The probe 220 is then offset an equal distance in opposite directions along the delta axis 602 from the delta prime reference point 700 and then descended until the probe 220 engages the three-dimensional calibration tool 304. Per the present embodiment, the probe 220 is offset to the delta one prime location 702 and the delta two prime location 704 by the specified distance 612. The specified distance 612 can be an equal distance in opposite directions from the delta prime reference point 700 along the delta axis 602. For purposes of illustration, the delta one prime location 702 and the delta two prime location 704 can be calculated by the following formulas:

the delta one prime location 702=the delta prime reference point 700 (plus) the known/given offset of the probe 220 (minus) the specified distance 612

the delta two prime location 704=the delta prime reference point 700 (plus) the known/given offset of the probe 220 (plus) the specified distance 612

All values used in the above equations can be either X-axis values or Y-axis values.

Per the present embodiment, the delta one prime location 702 corresponds to the first Z-axis location 706 and the delta two prime location 704 correspond to the second Z-axis location 708. It has been discovered by the present inventors that when the probe 220 descends to different heights on either side of the reference point 308 of the three-dimensional calibration tool 304 (e.g.—the height of the first Z-axis location 706 is different from the height of the second Z-axis location 708), that the known/given offset of the probe 220 is calibrated improperly with respect to the optical sensor 306. By way of example, the height of the probe 220 (i.e.—the first Z-axis location 706 and the second Z-axis location 708) can be measured when the probe encounters the resistance of the three-dimensional calibration tool 304. The difference in height between the first Z-axis location 706 and the second Z-axis location 708 is defined by the Z-height difference value 710.

The present inventors have also discovered that a delta calibration value can be calculated to compensate for the improper known/given offset value of the probe 220. For purposes of illustration, the delta calibration value can be calculated by the following formula:

the delta calibration value=the known/given offset of the probe 220 (minus) a delta adjust value; wherein the delta adjust value=the Z height difference value 710 (divided by) 2

In other words, the delta calibration value equals the known/given offset of the probe 220 minus the Z height difference value 710 divided by two. The above equation is simplified by knowing that, on a 45° angle, travel along the Z-axis is equal to travel along the X-axis and the Y-axis. The delta calibration value and the known/given offset of the probe 220 can be either X-axis values or Y-axis values.

By substituting the delta calibration value as the “new” known/given offset of the probe 220, the probe 220 can then be properly aligned by performing an iterative process, if necessary, until the probe 220 is correctly aligned over the reference point 308. This method of properly calibrating the probe 220 with respect to the optical sensor 306, of FIG. 3, ensures that each location and/or feature within the working envelope of the robotics system 200, of FIG. 2, is known accurately.

It is to be understood that this calibration method can be repeated for each offset axis (e.g.—the X-axis and the Y-axis) of the probe 220. For example, if the first set of calculations are performed for the X-axis, then the second set of calculations can be performed for the Y-axis, or vice-versa. Additionally, it is to be understood that this calibration method can also be repeated for each of the probe 220 within the head system 218, of FIG. 3.

Furthermore, it is to be understood that each of the coordinates for the X, Y and Z values of the probe 220 location are measured by the motor encoder/controller 310, of FIG. 3, and that software within the processing unit 312, of FIG. 3, then calculates any adjustments (i.e.—the delta calibration value and/or the delta adjust value) that need to be made to the known/given offset value for the probe 220. For example, the processing unit 312 may determine the position of the probe 220 relative to the optical sensor 306 based on the Z-axis values or height values obtained from the engagement of the probe 220 with the three-dimensional calibration tool 304.

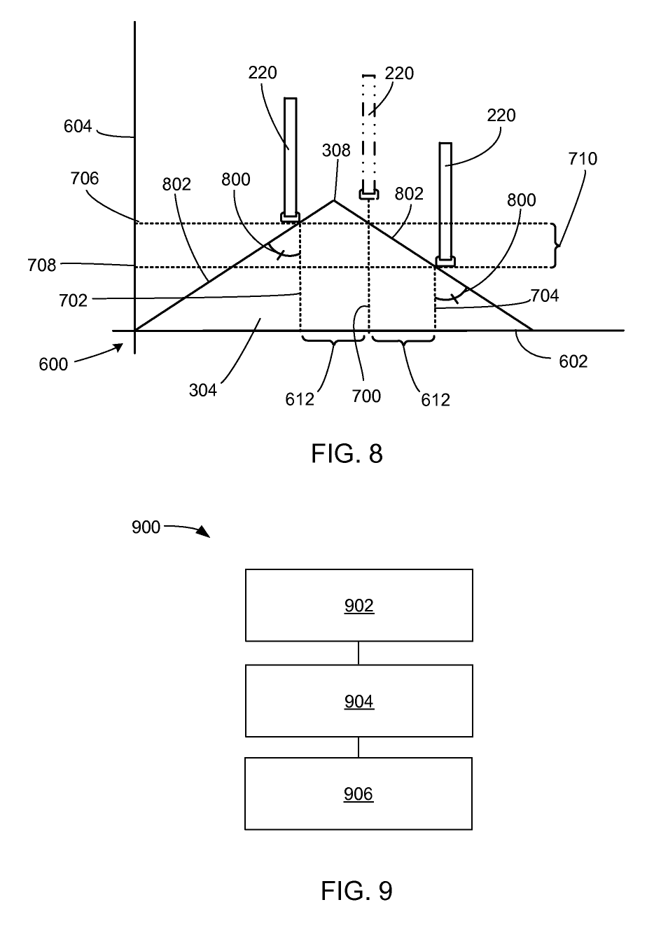

FIG. 8 depicts by way of example and not by limitation, a method that can be employed for calibrating the probe 220, of FIG. 3, with respect to the optical sensor 306, of FIG. 3, and is not to be construed as limiting. Per this embodiment, it will be assumed that each face of the three-dimensional calibration tool 304 is not at a forty-five degree (45°) angle with respect to the surface over which it is placed (e.g.—the substrate 302, of FIG. 3). Additionally, the delta axis 602 of the reference coordinate system 600 may represent both an X-axis orientation or a Y-axis orientation. As an exemplary illustration, the representation of FIG. 8 may depict the calibration of the probe 220, which is not properly calibrated.

Referring now to FIG. 8, therein is shown a front view of the three-dimensional calibration tool 304 and the probe 220, in accordance with another embodiment of the present invention. FIG. 8 depicts a similar configuration as to that shown in FIGS. 6 and 7, and consequently, only the differences between the figures will be described, to avoid redundancy. This view includes the probe 220, the three-dimensional calibration tool 304, the reference point 308, the reference coordinate system 600, the delta axis 602, the Z-axis 604, the specified distance 612, the delta prime reference point 700, the delta one prime location 702, the delta two prime location 704, the first Z-axis location 706, the second Z-axis location 708, the Z height difference value 710, an angle 800, and a sidewall 802.

The reference coordinate system 600 has been positioned adjacent the three-dimensional calibration tool 304 to provide a frame of reference for purposes of discussion. Per this embodiment, the probe 220 is aligned over the reference point 308 by locating the optical sensor 306, of FIG. 3, over the perceived location of the reference point 308 and then adding the known/given offset value for the probe 220. It is to be understood, that if the known/given offset value for the probe 220 is incorrect, then the probe 220 will most likely not be aligned over the reference point 308. The probe 220, shown in phantom outline, represents the start position of the probe 220 that is located by an incorrect known/given offset value. The start position of the probe 220 can be represented by the delta prime reference point 700.

The probe 220 is then offset an equal distance in opposite directions along the delta axis 602 from the delta prime reference point 700 and then descended until the probe 220 engages the three-dimensional calibration tool 304. Per the present embodiment, the probe 220 is offset to the delta one prime location 702 and the delta two prime location 704 by the specified distance 612. The specified distance 612 can be an equal distance in opposite directions from the delta prime reference point 700 along the delta axis 602. For purposes of illustration, the delta one prime location 702 and the delta two prime location 704 can be calculated by the following formulas:

the delta one prime location 702=the delta prime reference point 700 (plus) the known/given offset of the probe 220 (minus) the specified distance 612

the delta two prime location 704=the delta prime reference point 700 (plus) the known/given offset of the probe 220 (plus) the specified distance 612

All values used in the above equations can be either X-axis values or Y-axis values.

Per the present embodiment, the delta one prime location 702 corresponds to the first Z-axis location 706 and the delta two prime location 704 correspond to the second Z-axis location 708. It has been discovered by the present inventors that when the probe 220 descends to different heights on either side of the reference point 308 of the three-dimensional calibration tool 304 (e.g.—the height of the first Z-axis location 706 is different from the height of the second Z-axis location 708), that the known/given offset of the probe 220 is calibrated improperly with respect to the optical sensor 306. By way of example, the height of the probe 220 (i.e.—the first Z-axis location 706 and the second Z-axis location 708) can be measured when the probe encounters the resistance of the three-dimensional calibration tool 304. The difference in height between the first Z-axis location 706 and the second Z-axis location 708 is defined by the Z height difference value 710.

The present inventors have also discovered that a delta calibration value can be calculated to compensate for an improper known/given offset value of the probe 220. For purposes of illustration, the delta calibration value can be calculated by the following formula:

the delta calibration value=the known/given offset of the probe 220 (minus) a delta adjust value; wherein the delta adjust value=(the Z height difference value 710 (times) tan(theta one)) (divided by) 2

In other words, the delta calibration value equals the known/given offset of the probe 220 minus the product of the Z height difference value 710 times the tangent of theta one divided by two. Theta one can be defined as the angle 800 that occurs between a vertical line drawn from the delta one prime location 702 or the delta two prime location 704 and the sidewall 802 of the three-dimensional calibration tool 304. The delta calibration value and the known/given offset of the probe 220 can be either X-axis values or Y-axis values.

By substituting the delta calibration value as the “new” known/given offset of the probe 220, the probe 220 can then be properly aligned by performing an iterative process, if necessary, until the probe 220 is correctly aligned over the reference point 308. This method of properly calibrating the probe 220 with respect to the optical sensor 306, of FIG. 3, ensures that each location and/or feature within the working envelope of the robotics system 200, of FIG. 2, is known accurately.

It is to be understood that this calibration method can be repeated for each offset axis (e.g.—the X-axis and the Y-axis) of the probe 220. For example, if the first set of calculations are performed for the X-axis, then the second set of calculations can be performed for the Y-axis, or vice-versa. Additionally, it is to be understood that this calibration method can also be repeated for each of the probe 220 within the head system 218, of FIG. 3.

Furthermore, it is to be understood that each of the coordinates for the X, Y and Z values of the probe 220 location are measured by the motor encoder/controller 310, of FIG. 3, and that software within the processing unit 312, of FIG. 3, then calculates any adjustments (i.e.—the delta calibration value and/or the delta adjust value) that need to be made to the known/given offset value for the probe 220. For example, the processing unit 312 may determine the position of the probe 220 relative to the optical sensor 306 based on the Z-axis values or height values obtained from the engagement of the probe 220 with the three-dimensional calibration tool 304.

Referring now to FIG. 9, therein is shown a flow chart of an automated calibration system 900 for the automated calibration system 300 in accordance with an embodiment of the present invention. The automated calibration system 900 includes providing a three-dimensional calibration tool in a block 902; engaging the three-dimensional calibration tool with a probe in a block 904; and, determining the position of the probe relative to an optical sensor based on the engagement of the three-dimensional calibration tool with the probe in a block 906.

Generalized Summary

Generally, the process or method for calibrating a probe with respect to an optical sensor may include the following steps:
1. Determine the position of a reference point of a three-dimensional calibration tool by optical teaching.
2. Using the known/given offset of the probe to align the probe over the reference point.
3. Calculate a delta one location, a delta two location, a delta one prime location, and/or a delta two prime location.
4. Descend the probe at both the delta one location and the delta two location or the delta one prime location and the delta two prime location.
5. Determine a Z-axis value, a first Z-axis location, and/or a second Z-axis location.
6. Calculate a delta calibration value.
7. Repeat steps 2-6 for the Y-axis offset if steps 2-6 originally calculated the X-axis offset or vice-versa.
8. Repeat steps 2-7 for each additional probe.

Of course, it is to be understood that many modifications, additions, and/or omissions may be made to the present invention without departing from the scope or spirit of the claimed subject matter. For example, the above process or method may include more, fewer, or other steps.

From the above it will be understood that the present invention is applicable to what can be described as “devices”, “media” or “components”. Devices, media and/or components include a broad range of electronic and mechanical devices. The best mode describes programming of devices, media and/or components, which include, but are not limited to, Flash memories (Flash), electrically erasable programmable read only memories (EEPROM), programmable logic devices (PLDs), field programmable gate arrays (FPGAs), and microcontrollers. However, the present invention encompasses programming for all electronic, mechanical, hybrid, and other devices, media and/or components, which require testing, measurement of device characteristics, calibration, and other programming operations. For example, these types of devices, media and/or components would include, but not be limited to, microprocessors, integrated circuits (ICs), application specific integrated circuits (ASICs), micro mechanical machines, micro-electro-mechanical (MEMs) devices, micro modules, and fluidic systems.

It has been discovered that the present invention thus has numerous aspects. One such aspect is that the present invention permits calibration of a probe with respect to an optical sensor, thereby increasing the accuracy of a robotics system for locating features within a system.

Another aspect is that the present invention provides an automated calibration system, which prevents the introduction of human error common to manual alignment/calibration systems.

Yet another important aspect of the present invention is that it valuably supports and services the historical trend of reducing costs, simplifying systems, and increasing performance.

These and other valuable aspects of the present invention consequently further the state of the technology to at least the next level.

Thus, it has been discovered that the automated calibration system of the present invention furnishes important and heretofore unknown and unavailable solutions, capabilities, and functional aspects for calibrating a probe with respect to an optical sensor. The resulting processes and configurations are straightforward, cost-effective, uncomplicated, highly versatile and effective, can be implemented by adapting known technologies, and are thus readily suited for efficiently and economically manufacturing integrated circuit package devices.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations, which fall within the scope of the included claims. All matters hithertofore set forth herein or shown in the accompanying drawings are to be interpreted in an illustrative and non-limiting sense.

What is claimed is:

1. An automated calibration system comprising:
providing a three-dimensional calibration tool;
engaging the three-dimensional calibration tool with a probe; and
determining the position of the probe relative to an optical sensor based on the engagement of the three-dimensional calibration tool with the probe.

2. The system as claimed in claim 1 wherein:
engaging the three-dimensional calibration tool with the probe includes aligning the probe over the reference point using a known/given offset of the probe with respect to the optical sensor.

3. The system as claimed in claim 1 wherein:
engaging the three-dimensional calibration tool with the probe includes engaging the three-dimensional calibration tool on either side of a reference point.

4. The system as claimed in claim 1 wherein:
determining the position of the probe relative to the optical sensor includes measuring the height of the probe on either side of the three-dimensional calibration tool.

5. The system as claimed in claim 1 wherein:
determining the position of the probe relative to the optical sensor includes calculating a delta calibration value.

6. An automated calibration system comprising:
providing a three-dimensional calibration tool;
optically determining the position of a reference point of the three-dimensional calibration tool;
engaging the three-dimensional calibration tool with a probe; and
determining the position of the probe relative to an optical sensor based on the engagement of the three-dimensional calibration tool with the probe.

7. The system as claimed in claim 6 wherein:
optically determining the position of the reference point of the three-dimensional calibration tool includes using a first reference and a second reference.

8. The system as claimed in claim 6 wherein:
providing the three-dimensional calibration tool includes providing a pyramid shape.

9. The system as claimed in claim 6 wherein:
determining the position of the probe relative to the optical sensor includes determining the position of more than one of the probe relative to the optical sensor.

10. The system as claimed in claim 6 wherein:
determining the position of the probe relative to the optical sensor includes calculating a delta adjust value.

11. An automated calibration system comprising:
a three-dimensional calibration tool;
an optical sensor for optically determining the position of the three-dimensional calibration tool;
a probe for engaging the three-dimensional calibration tool; and
a processing unit for determining the position of the probe relative to the optical sensor based on the engagement of the probe with the three-dimensional calibration tool.

12. The system as claimed in claim 11 wherein:
the three-dimensional calibration tool is over a substrate.

13. The system as claimed in claim 11 wherein:
the three-dimensional calibration tool includes a pyramid.

14. The system as claimed in claim 11 wherein:
the three-dimensional calibration tool includes a pyramid with forty-five degree sides.

15. The system as claimed in claim 11 wherein:
the optical sensor detects changes in reflectivity.

16. The system as claimed in claim 11 wherein:
the probe is part of a head system that includes more than one of the probe.

17. The system as claimed in claim 11 wherein:
the probe is used for picking and placing devices, components, or media.

18. The system as claimed in claim 11 wherein:
the processing unit determines a delta adjust value.

19. The system as claimed in claim 11 wherein:
the processing unit determines a delta calibration value.

20. The system as claimed in claim 11 wherein:
the automated calibration system is part of an automated programming system.
